(19) United States
(12) Patent Application Publication
(10) Pub. No.: US 2002/0103756 A1
(43) Pub. Date: Aug. 1, 2002

(54) Business method for implementing on-line check acceptance and processing

(75) Inventors: Chet L. Andrews, Irvine, CA (US); Samuel A. Wheeler, Mission Viejo, CA (US)

Correspondence Address: Ladi O.Shogbamimu, SHOOK, HARDY & BACON L.L.P., 1200 Main Street, Kansas City, MO, 64105-2118, US

(73) Assignee: Valutech, Inc.

(21) Appl. No.: 09/910,246

(22) Filed: Jul. 20, 2001

Related U.S. Application Data
(60) Provisional application No. 60/265,383, filed on Jan. 30, 2001.

(51) Int. Cl. G06F 17/60

(52) U.S. Cl. 705/42; 235/379

(57) ABSTRACT

A method is provided for utilizing, accepting and processing checks on-line in a computer network environment. The method of the present invention provides for a payment settlement process that electronically originates a paper check for the settlement of on-line transactions. The method leverages processes that exist for handling paper checks within the banking system. In an embodiment of the present invention, a user may select an option to settle a transaction by check, then the user is prompted for personal and financial information to facilitate the creation of a check and to guarantee the availability of funds. The guarantee of funds precludes an on-line merchant from any involvement in the process of receiving payment on a returned check. In a further embodiment of the present invention, the collected information is transferred to a participating bank where a check is printed and deposited. Records of the transaction are also generated and maintained for all the parties involved.

### CROSS-REFERENCE TO RELATED APPLICATIONS

This application claims the benefit of U.S. provisional application Serial No. 60/265,383 filed Jan. 30, 2001.

### FIELD OF INVENTION

The present invention relates to a method for utilizing, accepting and processing checks on-line in a computer network environment. More specifically, this invention relates to a method for the electronic input of a financial settlement payment that utilizes the optimized paper payment processing and back office settlement operations.

### BACKGROUND OF THE INVENTION

Historically, consumers have used the paper check as a method of payment for goods and services. In fact, statistics show that 81% of all consumer bills are paid by check, 86% of all business-to-business (B2B ) payments are by check and 88% of the United States population has a checking account. There are also statistics showing that consumers prefer checks 4 to 1 over credit/debit cards. In 1999, there were 69 billion paper checks cleared thru the Federal Reserve system while only 4 billion ACH transactions were recorded for the same period. Further, it is well known that checks have a lower transaction cost than credit/debit cards.

The advent of electronic commerce has changed the way in which most people purchase goods and services. A large percentage of consumers and businesses now utilize the Internet to make these purchases. Part of the reason for this growth has been the convenience of locating products and the ability to promptly have the product delivered. Until now, the only means of facilitating this prompt shipment has been to make payments using a credit/debit card or to have the goods shipped Cash On Delivery (COD). During 1999 and 2000, 98% of all Internet payments were settled via credit card transactions.

Product vendors, electronic merchants (E-merchants), e-commerce, call centers, (Electronic Billing Presentment and Payment) EBPP, etc., need a way that is both cost effective and efficient for both themselves and their customers to exchange goods for money. A method of payment by the customer that assures the merchant that he/she will receive the funds and that provides a record of the transaction between the parties will make it possible for commerce to flourish. Furthermore, there is a need for a method of Internet payment that embraces consumer acceptance of the paper check, exploits the core competency of banks in the check clearing and settlement infrastructure, and meets the merchant's desire for a hands free payment settlement method.

The most effective means to accomplish the exchange process is to have a face-to-face exchange between the consumer and the merchant. However, such a requirement is neither practical nor desirable by either of the parties because it essentially limits commercial opportunities and competitive purchasing. Above all, it defeats the entire concept of e-commerce, which is to allow electronic sale and purchase. As such, over the years there have been many efforts to simplify the exchange of merchandise for money on the Internet. The credit card, and later, the debit card have been used extensively to achieve this goal as have various electronic, EFT, ACH based payment schemes. However, in all of these cases some consumers have been left out of the picture for a variety of reasons. In some cases, it has been because the consumers are unable to meet the requirements to obtain a credit/debit card and in other cases it has been a matter of individual consumer choice not to acquire a credit/debit card. There is also a population of consumers who have credit/debit cards that chose not to use them for traditional or electronic purchases primarily because of security concerns.

All of these factors, as well as consumer attitudes, result in the substantial loss of business to E-merchants. There is an even greater potential to obtain new market potential via this present invention. Currently there are 80 million Americans with checking accounts and no credit cards. There are also 40 million Americans with credit cards and zero available credit line. These two groups provide a total of 120 million Americans who cannot currently make payments via the Internet. There is also a significant market potential in the prime marketing age group of the 15 to 21 year old. This age group has significant purchasing power in the brick and mortar world but few have credit cards to allow them to participate in online payments world. An invention is needed that opens all of these markets to every online merchant, business, EBPP, e-commerce, payment portal, etc.

Of particular relevance to this invention is the fact that in all of the situations described above, a majority of the non-card users continue to use paper checks for non-electronic purchases. Another sector of the population continues to use paper checks for bill payments and other types of transactions as indicated by the statistics referenced above.

Accordingly, there exists a need for a method of doing business that allows paper check writing consumers to use a payment method that is comfortable and convenient to them. There is also a need for such a method and system to further commerce in the electronic age without making a true and tried transaction infrastructure, i.e. the check processing banking process, obsolete.

### SUMMARY OF THE INVENTION

The present invention provides a method for use in electronic commerce which allows consumers and businesses to use paper checks in their transactions with E-merchants. In accordance with the method, E-merchants are able to offer an additional option for payment that will facilitate prompt shipping of purchased goods and receipt of payment.

The method of the present invention also ensures that E-merchants will receive 100% guaranteed payment on checks that are issued by purchasers. The need for a merchant to get involved in collection of returned checks is eliminated by incorporating third party check verification and the guarantee of the receipt of funds with the settlement process.

Further, the method of the present invention allows a purchaser to receive the benefit of obtaining a canceled check with their monthly statement, and allows the current check users to save the cost of postage and the inconvenience of mailing the check. The canceled check serves as a receipt of every purchase transaction, proof of purchase and confirmation of payment.

The method of the present invention further results in saving E-merchants and other vendors the typical processing costs associated with credit/debit cards.

The method of the present invention further allows banks to offer an electronic payment solution that utilizes their existing check clearing and collection infrastructure, while also allowing the banks to generate revenues and profits from the transactions.

A method that offers an electronic lockbox service by the bank is provided to e-merchants while also allowing the purchasing consumer to enjoy a preferred payment method, the paper check.

Additional advantages and novel features will be set forth in the description which follows. In part these features may become apparent to those skilled in the art upon examination of the following, or may be learned by practice of the invention. The objects and advantages of the invention may be realized and attained by means, instrumentalities and combinations particularly pointed out in the appended claims.

### BRIEF DESCRIPTION OF THE DRAWINGS

In the accompanying drawings which form part of the specification and are to be read in conjunction therewith and in which like reference numerals are employed to indicate like parts in the various views:

FIG. 1 is a block diagram illustrative of a communication network suitable for use in implementing a method of the present invention;

FIG. 2 is a block diagram illustrative of a communication network suitable for use in implementing an embodiment of the present invention as well as illustrative of information flow in the method of the present invention;

FIG. 3 is a block diagram illustrative of a communication network with an alternate configuration and information flow;

FIG. 4 is an exemplary illustration of a user interface display for collecting and displaying the personal information that is provided by a consumer;

FIG. 5 is an exemplary illustration of a user interface display of a check image and key pad that is presented to the on-line purchaser in the method of the present invention; and

FIG. 6 is an exemplary illustration of a user interface display of a check image that is presented to the on-line consumer for final approval in the method of the present invention.

### DETAILED DESCRIPTION OF THE INVENTION

The present invention is directed to a method for utilizing, accepting and processing checks on-line in a computer network environment. The particular embodiments described herein are intended in all respects to be illustrative rather than restrictive. Alternative embodiments will become apparent to those skilled in the art to which the present invention pertains without departing from its scope.

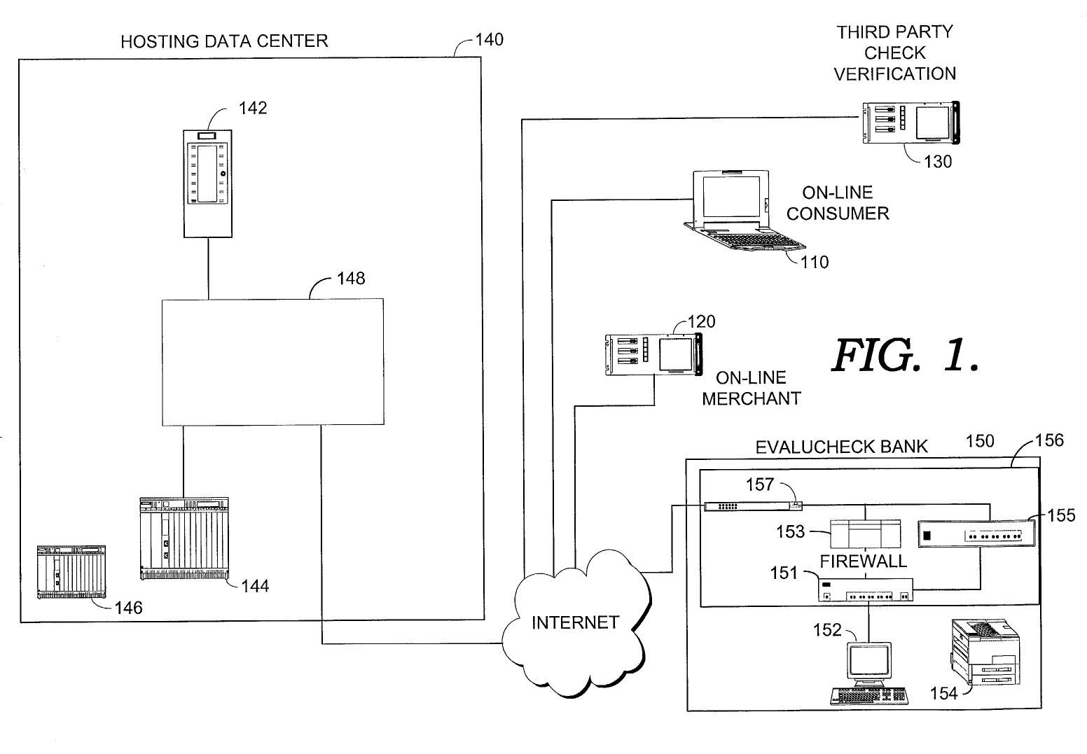

The present invention provides a method for implementing an on-line purchase for immediate shipment by payment with a check. The invention is operable with numerous general or special purpose computing systems that are able to communicate in a networked environment. In particular, an embodiment of this invention utilizes five operational units that can reside on one or more separate systems, without regard to geographic location or proximity. Each of the operational units and the connection between them are illustrated in FIG. 1. The utilized units are namely an E-merchant 120, an on-line consumer 110, a hosting data center 140, one or more e-ValuCheck banks 150, having the necessary hardware and software to offer electronic check services and a third party check verifier 130. An on-line consumer 110 is typically a user with a computer having access to a network. One activity of network users particularly those on the Internet is shopping. For this reason, there are several sites set-up to accommodate this activity, namely in E-merchant 120. An E-merchant offers goods for sale in exchange for payment. The payment options have traditionally included cash on delivery (COD), and credit cards. A new payment option is being provided by this invention, on-line payment by check. Payment by check is facilitated by a hasty data center 140 that provides the functions of webservers 142, as database 144, an application server 146 and communications equipment 148. It should be noted that while each of these functions are depicted on individual systems, they may be combined and performed from one or more computing systems. The webserver 142, typically hosts the web pages and associated modules that would enable a web page that is being viewed by the on-line consumer 110. A database 144 is a structured central repository for data and information. An application server 146 provides a central location for the deployment and execution of system and user programs. All of the previously discussed components are connected to each other and external systems via a host of communications equipment 148. Examples of such communications equipment includes firewalls, hub, routers, switches and an assortment of modems. An e-ValuCheck bank is essentially a participating bank that has chosen to offer the electronic check services described herein to its merchant clients. The bank is also one that has installed the necessary computer hardware and software to enable check printing at its site. It should be noted that alternative embodiments that combine or separate the operational units described above are within the scope of this invention.

Typically, a user of on-line consumer unit 110 initiates the method of the present invention by making a purchase from an operator of E-merchant unit 120 via the Internet. The user will be presented with, among other things, a screen requiring certain billing and shipping information. After completing the required billing/shipping data input in the E-merchant's web page, the consumer will be prompted to select a method of payment. In an embodiment of the present invention, the consumer will be presented with an option to select “Pay by Check for Immediate Shipment” by clicking on a check logo within the E-merchant's web page.

The check logo will be associated with a hyperlink to hosting data center 180. More specifically, the hyperlink from the check logo provides a seamless transfer to an e-ValuCheck Web Server 142 and also sends the consumer's billing/shipping information (e.g. name, address, e-mail, etc). Other identification data may also be collected from the consumer, such as a driver's license number. The web-server 142 then connects to a third party check guarantee or verification service 130 to approve or disapprove the check transaction. The response from guarantee service 130 is communicated back to the on-line consumer unit 110, such as on the display or other medium. E-ValuCheck will also communicate with additional third party service provider for identity and date of birth verification. This communication and approval process is very similar to the third party check guarantee service. The process will send consumer information to both check and identity verification service providers via the Internet. In the case of the identity and date-of-birth verification service, the service provides a FICO type rating number between 0 and 1000. The higher the number the more certain we are of the true identification of the consumer. This scoring model is created by checking our consumer information against 56 different databases to look for possible discrepancies, which might cast doubt upon the identity of each consumer. The system of the current invention will allow merchants to assign acceptable scoring rating by individual merchant account. In other words, a seller of digital content information may accept a lower identification scoring than will a seller of $5,000 computer systems. The date-of-birth verification is a very valuable feature for the online gaming and adult content providers, as they are anxious to comply with age restrictions wherever possible. Until now they have had no way to confirm date-of-birth for online consumers. E-ValuCheck will allow these online merchants to better comply with local regulations concerning age requirements for participation in each of these services.

Following the various verification processes, in the event that an approval is granted, the user of consumer unit 110 is then required to confirm the transaction before the E-merchant can fulfill the order. A fulfillment includes the E-merchant shipping the purchased items, notifying the e-ValuCheck servers 142 of the transaction and requesting payment from the user of the consumer unit 110 for the purchased items. Since the check is guaranteed by the third party verifier, the E-merchant will ship the product immediately.

A database 146 and an application server 144 are provided within hosting data center 140 that operates to process and generate the information necessary to print the check. This information includes among other things the payee, amount, account number and check routing information. The system of the present invention verifies banking information via the traditional banking database and other methods that exist within financial institutions. The check printing information is then transmitted from data center 140 to an e-ValuCheck bank 150 where a check is printed on printer 154, such as an MICR printer, and deposited in the bank. The checks to be printed can be spread between a geographically dispersed matrix of e-ValuCheck banks. The e-ValuCheck bank where a particular check gets printed is selected based on a clearings database, which is an information store that attempts to minimize the check float that will occur for each merchant deposit.

The connection between the bank 150 and the hosting data center 140 is a secure link, such as a Virtual Private Network (VPN) or other equivalent that is provided with combinations of hardware and software devices 148, 156. An exemplary combination of hardware for such network is shown with a DSL router 157, a firewall 153, a hub 151 and a switch 155, collectively designated as device 156. It should be understood that device 148 may contain similar communications devices. It should also be noted that the indicated devices 148,156 represent network security and connectivity systems that are the current state of the art. Those knowledgeable in the art will recognize that with the advancement of technology, the nature, quantity and types of these devices that are required to enable this invention will vary while still providing the equivalent functionality. Such variations are contemplated to be within the scope of the present invention.

Once a check is printed, a deposit is made in the usual way to the account of the E-merchant. The system prints fully MICR encoded checks at printer 154, with associated deposit slips, batch tickets, tray tickets, large deposit separators, etc. In other words, in addition to printing the check, all other associated documents used in a traditional banking system are also generated and printed at the bank 150. Information relating to the deposit is provided to the E-merchant via an on-line processing and balance reporting system 152 within bank 150.

In the event that any check items are returned as unpayable, the cost of the items will be forwarded and charged against an account of the check guarantee provider, 130. This eliminates all handling or processing by the E-merchant of the back-end check payment procedures.

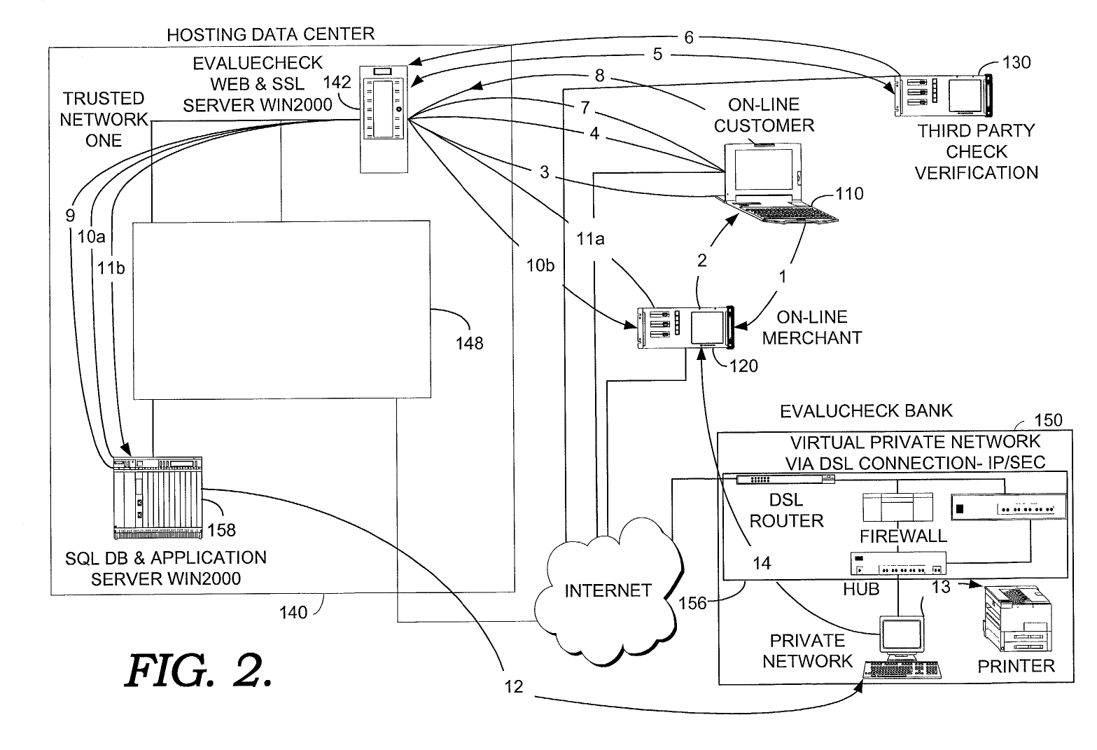

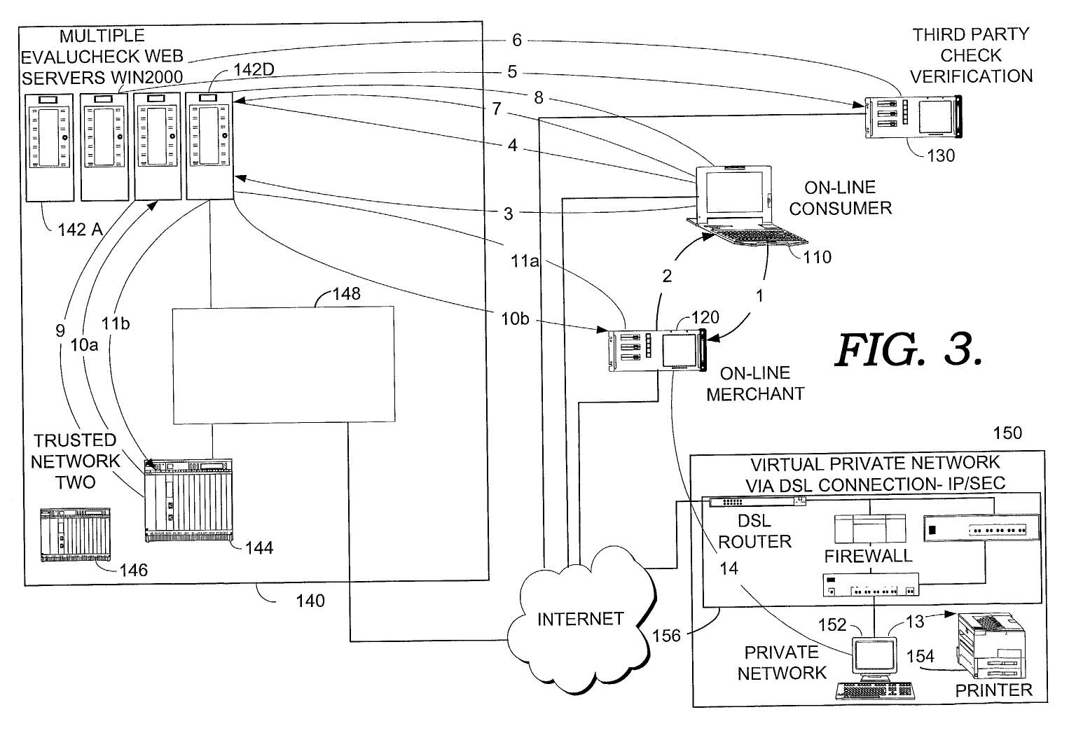

As previously mentioned, there are multiple permutations for practicing this business method. For instance, the constituent operational units of this inventive process may be combined in a variety of ways. In FIG. 2, each of the units are shown operating on individual computing systems that may or may not be geographically dispersed. Alternatively, the units may be spread across multiple computing systems 142A-D, as shown in FIG. 3. It is also within the scope of this invention for operational units to exist on one hardware platform.

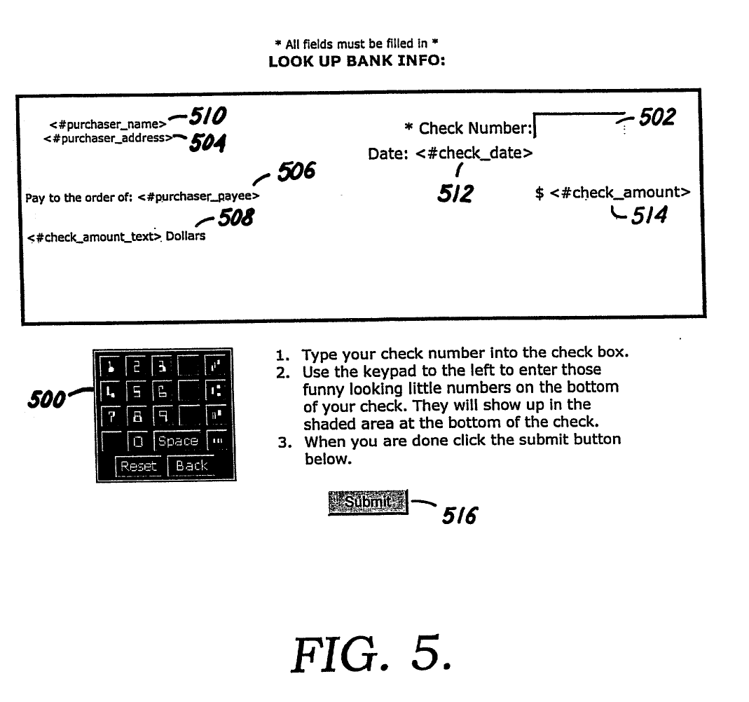

Both the informational steps and the steps for carrying out this invention can also be performed in different sequences. In one embodiment of this invention the steps which are depicted in the network site architecture of FIG. 2 and FIG. 3 are indicative of a process flow option of the present invention. First in step 1, an operator of on-line consumer unit 110 will access the Internet and can select a product to purchase from an E-merchant web site. The operator of unit 110 can input personal billing/shipping information into a provided E-merchant on-line form. In step 2, the E-merchant 120 assigns a pending purchase order number and queries the on-line consumer regarding a choice of payment method. In step 3, the on-line consumer can select the e-ValuCheck payment method (Pay by check for Immediate Shipment) by clicking on a provided e-ValuCheck Logo on the E-merchant web site. This action causes processing control to be transparently transferred to the e-ValuCheck host Web Server 142. In step 4, the on-line consumer 110 is prompted to confirm the personal information that was transferred from the E-merchant web site. The consumer then submits any information requested by server 142 (e.g. driver's license number) as part of the identification and approval process. In step 5, the e-ValuCheck host 140 submits a request for a check guarantee approval/denial to a third party service 130. In step 6, the e-ValuCheck host 140 receives the check guarantee approval/denial response from service 130 and also displays it to the on-line consumer 110 at step 7. In step 8, the on-line consumer 110 submits final check payment authorization to e-ValuCheck host 140, using a method such as the one depicted in FIG. 5, as more fully described below. In step 9, the e-ValuCheck host 140 posts payment transactions to the e-ValuCheck SQL transactions/applications database server 144,146. In step 10, the e-ValuCheck SQL database 146 forwards any pending purchase order numbers and third party check guarantee approvals/denials to the E-merchant 120 via server 142. This action provides notification to the merchant that an order needs to be shipped out. In step 11a, 11b, upon the fulfillment of a shipping order, the E-merchant instructs the e-ValuCheck host 140 to initiate a check printing function at the e-ValuCheck bank 150. In step 12, e-ValuCheck host 140 transmits check payment transaction instructions to the e-ValuCheck bank 150. In step 13, the e-ValuCheck bank prints the check files according to the bank availability schedule, on the printer 154. Finally in step 14, the e-ValuCheck bank 150 submits deposit information to the E-merchant 120 via an on-line balance reporting function.

Each e-ValuCheck bank can print the e-ValuCheck paper drafts at any time during the day or night, depending upon their check clearing availability schedule. At the end of every day these banks will run a final “end-of-day” processing print run. This print run calculates all fees incurred on a merchant-by-merchant basis for that day and issues corresponding settlement checks between the bank, the third party check guarantee company and e-ValuCheck. At the end of every business processing day, e-ValuCheck will issue paper drafts to collect all bank transaction service fees charged for the e-ValuCheck product on a merchant-by-merchant basis. E-ValuCheck then issues paper drafts payable to e-ValuCheck from each processing bank to collect the item transaction fee charges from each bank. This same process will occur for all check guarantee fees as well. E-ValuCheck is unique in that it will calculate and collect all transaction and check guarantee fees on a daily basis. This feature will provide significant cash flow benefits to the banks and check guarantee companies involved with e-ValuCheck. This feature also limits the merchant's payment risk on these transactions to the amount of a single day's activity fees. As part of the end-of-day processing function, e-ValuCheck can also calculate and collect any reserve holdback amounts as required by the bank or the check guarantee company. These reserve holdback amounts would be held by the bank and the check guarantee company for a rolling period, usually for two months, so to minimize the risk of return items from consumers. The calculation and collection of all bank fees, check guarantee discount percentages and required reserve holdback amounts, is unique to e-ValuCheck.

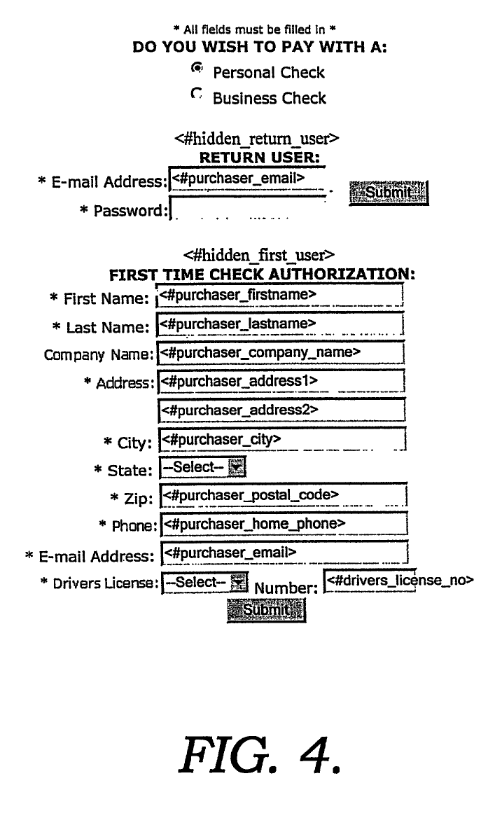

An on-line consumer provides the information that is utilized for check authorization through a provided interactive web page. FIG. 4 shows the type of information that may be sought as well as, a depiction of how that request may be presented to the consumer. For example, in an embodiment of the present invention, an address and other personal information fields are provided on the screen to illicit those pieces of information from a user. It should be noted that an on-line consumer is only required to provide this information the first time that they use the check authorization. On subsequent uses of the check authorization, a ‘return user’ will only need to provide their unique e-mail address and a password for identification purposes. Thereafter, the system can recall previously entered information that is associated with this unique user information.

Additionally, e-ValuCheck offers consumers, a “registered user” status. Under normal circumstances, any consumer can access e-ValuCheck for a predetermined dollar amount of say $500 every 30 days. However, in order to access an e-ValuCheck payment transfer of more than $500, a consumer must become a “registered user”. This status can be obtained in two different manners. First, the consumer can obtain a digital certificate to verify their identity. This process can be coordinated through the e-ValuCheck bank that will serve as the registration authority for consumer digital certificates. With this option, the system will allow the e-ValuCheck bank to participate and guarantee the identity of each consumer. The second method available to obtain “registered status” will require the consumer to supply e-ValuCheck with their personal checking account information. A validation process through transfers and confirmations ensues to establish the authority of the consumer to access the transactional activity of that personal bank account. Both of these processes allow e-ValuCheck confirm the identity of the consumer and therefore use the e-ValuCheck system to transfer larger amounts of money.

In addition to the personal information referenced above, an on-line consumer must also provide banking information 502-514, such as found on the typical paper check. In FIG. 5, a check image 501, a keypad 500 and instructions that would be displayed to a consumer are shown. With the aid of the keypad 500, the on-line consumer can enter all the information that would normally be found on their paper check including the MICR line. It should be noted that some of the information that was previously provided by a user in other parts of the same transaction session, such as purchaser name, purchaser address, payee and check date may be automatically filled in by the system. It is also possible in the case of an authorized ‘return user’, for the entire check with the exception of the check number, to be filled in by the system. When data entry is complete the user can use the submit button 516 to send the information to the host system.

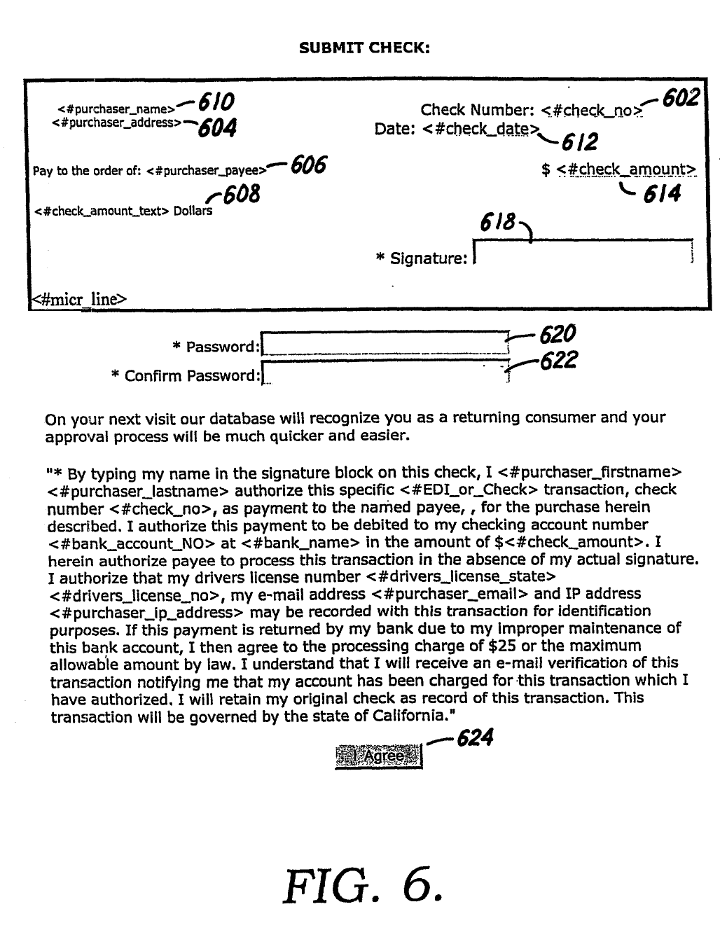

An exemplary final display related to the check settlement that is seen by the consumer is shown in FIG. 6. As shown, all check entries are completed with the exception of the signature text box. Entry of the consumer s name, password and password confirmation will complete the consumers entry process. The selection of the agreement button will then initiate the authorization and payment processes that were earlier described. It should be noted that alternative methods of providing consumer acknowledgment, consent or verification are within the scope of this invention.

E-ValuCheck also offers a preferred consumer payment option to other product/service vendors such as utility and phone companies, for EBPP models wherein credit cards do not work very well. These vendors are able to incorporate e-ValuCheck into their online billing products. Furthermore, banks can use e-ValuCheck to allow consumers to make monthly payments towards online credit card bill presentations. In other words, e-ValuCheck can provide a standard for EBPP payment options.

It should be understood that a user may call into a remote location where an operator performs the functions discussed this far.

In addition to the features described herein, the present invention provides a consumer with the ability to identify and assign an account “forwarding account” into which funds can be transferred from an e-ValuCheck bank. A forwarding account could be another bank account, a bill payment account, or other such account.

The method and system of the present invention provides several advantages to consumers, merchants, vendors and financial institutions. By utilizing technological advancements and integrating into existing financial processes, the present invention minimizes disruptions while providing the unique benefits that were discussed above. From the consumers perspective, the current invention accommodates divergent needs by incorporating old and new processes in such a way as to allow the consumer to benefit from the ease and versatility of technology while still providing an acceptable level of comfort, for the disbursement of money. Merchants and vendors benefit from being able to potentially reach new consumers, as well as to have solutions that enable them to streamline and efficiently receive payment. Financial institutions are able to provide additional and convenient services to their entire client base through the current invention, while also meeting their own business objectives.

Alternative embodiments of the present invention will become apparent to those skilled in the art to which it pertains upon review of the specification, including the drawing figures. The various systems and methods showing in FIGS. 1-6 and described in the specification are merely exemplary of those suitable for use in connection with the present invention. Accordingly, the scope of the present invention is defined by the appended claims rather than the foregoing description.

We claim:

1. A method for a payment settlement process that electronically originates a paper check settlement for online transactions comprising the steps of:
providing an option to pay by check;
obtaining necessary personal and financial information to allow check creation;
obtaining a guarantee of the funds;
transferring check print information to a check printing and depositing bank; and
providing confirmation of transaction to all parties.

2. The method as recited in claim 1 further comprising the step of:
generating records and materials necessary to effectuate a deposit of funds to the proper account; and
providing information on fund deposits.

3. A method as recited in claim 1, wherein said selection of an option to settle by check comprises:
selecting an icon that is located on the E-merchant s web page; and
transferring control and information to a host Web server.

4. A method as recited in claim 1, wherein said necessary personal and financial information to allow check creation is directly obtained from the consumer.

5. A method as recited in claim 1, wherein said necessary personal and financial information to allow check creation is recalled from a previous consumer transaction.

6. A method as recited in claim 1, wherein said guarantee of funds comprises the steps of:
sending purchase amount and personal information to a third party check verifying/guarantee vendor;
receiving a response from said third party vendor;
displaying said response to the purchaser; and
prompting the purchaser for final acceptance of the transaction.

7. A method as recited in claim 1, wherein said generating of records necessary to effectuate a deposit of funds to the proper account comprises the steps of:
posting a payment transaction to a database server;
forwarding an e-merchant transaction tag and third party approval to an e-merchant;
obtaining said e-merchant instructions to print a paper check;
printing said paper check; and
depositing said paper check into the account of said e-merchant.

8. A computer readable medium having computer executable instructions for performing the method recited in claim 1.

9. A computer system having a processor, a memory and an operating environment, the computer system operable to execute the method recited in claim 1.

10. A method in a computer system having a graphical user interface including a display for displaying and a means for enabling entry of a plurality of purchaser informational items in the computer system, said method comprising:
displaying a check image; and
displaying a plurality of labels and alphanumeric entry boxes for prompting and accepting said purchaser informational items.

11. A method as recited in claim 10 wherein displaying of said check image comprises:
displaying a purchaser name;
displaying a purchaser address;
displaying a check number;
displaying a check date;
displaying a check amount;
displaying a payee name;
displaying an MICR-line; and
displaying a signature entry.

12. A method as recited in claim 10, wherein the means for entry of information by a purchaser is with a keyboard.

13. A method as recited in claim 10, wherein the means for entry of information by a purchaser is on a displayed keypad, wherein said keypad has a plurality of buttons and wherein said buttons depict characters and symbols found on a paper check.

14. A method as recited in claim 11, wherein said check image is arranged and displayed in a similar format as a paper check.

15. A computer readable medium having computer executable instructions for performing the method recited in claim 10.

16. A computer system having a processor, a memory, an operating environment, and Internet access, the computer system operable to execute the method recited in claim 10.

17. A system for settlement processing comprising:
means for secure communications between an on-line merchant, on-line consumer, third party check verifier and a system for generating paper checks;
means for tracking and handling purchase transactions;
means for presenting and collecting user and check information;
means for processing check and banking information;
means for initiating the generation of one or more paper checks;
means for guaranteeing the availability of funds; and
means for selecting optimal check clearing locations from a matrix of available banks.

18. A system for generating paper checks from a purchase transaction comprising:
means for generating a paper check;
means for reporting check printing and deposit activity; and
means for securely communicating with a check payment processing system.

19. A method for handling the settlement of checks comprising:
identifying a forwarding account;
funding said forwarding account; and
returning check items against said forwarding account.

20. A method as recited in claim 19 wherein said identifying includes having a merchant select to guarantee a deposit to a first bank by identifying a second bank account for charge back items.

21. A method as recited in claim 19 wherein said funding of said forwarding account is by one or more check guarantee service.

22. A method as recited in claim 19 wherein said funding of said forwarding account includes the deposit of fees payable to the guarantee service.
